(19) United States
(12) Patent Application Publication
(10) Pub. No.: US 2011/0115937 A1
(43) Pub. Date: May 19, 2011

(54) Information processing apparatus, information processing method, and program

(75) Inventor: Akira Sassa, Saitama (JP)

(73) Assignee: Sony Corporation, Tokyo (JP)

(21) Appl. No.: 12/925,427

(22) Filed: Oct. 20, 2010

(30) Foreign Application Priority Data
Nov. 18, 2009 (JP) P2009-262513

(51) Int. Cl. G06K 9/46; H04N 5/228

(52) U.S. Cl. 348/222.1; 382/190; 348/E05.024

(57) ABSTRACT

An information processing apparatus includes an estimation unit estimating a group to which a subject shown in the registration images belongs in accordance with the frequency with which the subject is shown together in the same image; and a selection unit selecting an image showing a subject which is estimated to belong to the same group as a subject shown in a key image given as search criteria from the plurality of the registration images in a situation where a group to which the subject belongs is estimated.

### BACKGROUND OF THE INVENTION

1. Field of the Invention

The present invention relates to an information processing apparatus, an information processing method, and a program. More specifically, the present invention relates to an information processing apparatus, an information processing method, and a program that are suitable for a situation where a slide show is to be performed after searching a large number of stored images to select images showing a person that is estimated to be related to a human subject shown in a key image given as search criteria.

2. Description of the Related Art

Most of existing digital still cameras have a “slide show” function. The use of the slide show function makes it possible to reproduce and display images, which were picked up and stored, sequentially in the order of photographing for example, or in a random order (refer, for example, to Japanese Unexamined Patent Application Publication No. 2005-110088).

### SUMMARY OF THE INVENTION

When a large number of stored images are displayed using an existing slide show function, it takes a long time to finish viewing all such stored images because there are so many images. This problem can be avoided by performing a slide show after searching a large number of picked-up images to select images satisfying certain criteria.

It is desirable to search a large number of stored images and select images related to a subject in a key image given as search criteria.

An information processing apparatus according to an embodiment of the present invention searches a plurality of registration images to select images satisfying search criteria. The information processing apparatus includes estimation means and selection means. The estimation means estimates a group to which a subject shown in the registration images belongs in accordance with the frequency with which the subject is shown together in the same image. The selection means selects an image showing a subject which is estimated to belong to the same group as a subject shown in a key image given as search criteria from the plurality of the registration images in a situation where a group to which the subject belongs is estimated.

The information processing apparatus according to the embodiment of the present invention may further include calculation means for calculating evaluation values of the registration images in accordance with the result of analysis by the image analysis means. The selection means may select images showing a subject estimated to belong to the same group as the subject shown in the key image from the plurality of registration images in the order of the evaluation values.

The calculation means may calculate the evaluation values of the registration images in accordance with compositions of the registration images as well as the result of analysis by the image analysis means.

The information processing apparatus according to the embodiment of the present invention may further include imaging means for picking up at least one of the registration images and the key image.

An information processing method according to the embodiment of the present invention is used in an information processing apparatus that searches a plurality of registration images to select images satisfying search criteria. The information processing method includes the steps of causing the information processing apparatus to estimate a group to which a subject shown in the registration images belongs in accordance with the frequency with which the subject is shown together in the same registration images and select an image showing a subject which is estimated to belong to the same group as the subject shown in the key image given as search criteria from the plurality of the registration images in a situation where a group to which the subject belongs is estimated.

A program according to the embodiment of the present invention controls an information processing apparatus that searches a plurality of registration images to select images satisfying search criteria. The program causes a computer included in the information processing apparatus to perform a process including the steps of estimating a group to which a subject shown in the registration images belongs in accordance with the frequency with which the subject is shown together in the same registration images and selecting an image showing a subject which is estimated to belong to the same group as the subject shown in the key image given as search criteria from the plurality of the registration images in a situation where a group to which the subject belongs is estimated.

An information processing method according to the embodiment of the present invention includes the steps of causing the information processing apparatus to extract a feature amount of a face of a person shown in registration images; classify the facial feature amount extracted from a plurality of registration images into a cluster to which a personal ID is assigned in accordance with similarity in the facial feature amount; associate the personal ID assigned to the cluster, into which the feature amount is classified, with the face of the person shown in the registration images; and estimate a group to which a person shown in the registration images belongs in accordance with the frequency with which the person is shown together in the same registration images. Further, the embodiment of the present invention includes the steps of causing the information processing apparatus to extract a feature amount of a face of a person shown in a key image given as search criteria; classify the facial feature amount extracted from the key image into a cluster to which a personal ID is assigned in accordance with similarity in the facial feature amount; associate a personal ID assigned to the cluster, into which the feature amount is classified, with the face of the person shown in the key image; and select an image showing a person who is estimated to belong to the same group as the person shown in the key image.

The information processing apparatus according to another embodiment of the present invention searches a plurality of registration images to select images satisfying search criteria. The information processing apparatus includes image analysis means, classification means, association means, and selection means. The image analysis means extracts a feature amount including a facial expression of a person shown in an image. The classification means classifies the facial feature amount, which is extracted from the image, into a cluster to which a personal ID is assigned, in accordance with similarity in the facial feature amount. The association means associates the personal ID assigned to the cluster, into which the feature amount is classified, with the face of the person shown in the image. The selection means selects an image showing a person shown in a key image given as search criteria that has a facial expression similar to the facial expression of the person shown in the key image from the plurality of analyzed registration images showing the face of a person to which a personal ID is assigned.

The information processing apparatus according to the other embodiment of the present invention may further include calculation means for calculating evaluation values of the registration images in accordance with the result of analysis by the image analysis means. The selection means may select images showing a person shown in the key image that have facial expressions similar to the facial expression of the person shown in the key image from the plurality of registration images in the order of the evaluation values.

The calculation means may calculate the evaluation values of the registration images in accordance with compositions of the registration images as well as the result of analysis by the image analysis means.

The information processing apparatus according to the embodiment of the present invention may further include imaging means for picking up at least one of the registration images and the key image.

An information processing method according to the embodiment of the present invention is used in an information processing apparatus that searches a plurality of registration images to select images satisfying search criteria. The information processing method includes the steps of causing the information processing apparatus to extract a feature amount including a facial expression of a person shown in the plurality of registration images; classify the facial feature amount, which is extracted from the registration images, into a cluster to which a personal ID is assigned, in accordance with similarity in the facial feature amount; associate the personal ID assigned to the cluster, into which the feature amount is classified, with the face of the person shown in the registration images; extract a feature amount including a facial expression of a person shown in a key image given as search criteria; classify the facial feature amount extracted from the key image into a cluster to which a personal ID is assigned in accordance with similarity in the facial feature amount; associate the personal ID assigned to the cluster, into which the feature amount is classified, with the face of the person shown in the key image; and select an image showing the person shown in the key image that has a facial expression similar to the facial expression of the person shown in the key image.

A program according to the embodiment of the present invention controls an information processing apparatus that searches a plurality of registration images to select images satisfying search criteria. The program causes a computer included in the information processing apparatus to perform a process including the steps of extracting a feature amount including a facial expression of a person shown in the plurality of registration images; classifying the facial feature amount, which is extracted from the registration images, into a cluster to which a personal ID is assigned, in accordance with similarity in the facial feature amount; associating the personal ID assigned to the cluster, into which the feature amount is classified, with the face of the person shown in the registration images; extracting a feature amount including a facial expression of a person shown in a key image given as search criteria; classifying the facial feature amount extracted from the key image into a cluster to which a personal ID is assigned in accordance with similarity in the facial feature amount; associating the personal ID assigned to the cluster, into which the feature amount is classified, with the face of the person shown in the key image; and selecting an image showing the person shown in the key image that has a facial expression similar to the facial expression of the person shown in the key image.

An information processing method according to another embodiment of the present invention includes the steps of causing the information processing apparatus to extract a feature amount including a facial expression of a person shown in a plurality of registration images, classify the facial feature amount extracted from the registration images into a cluster to which a personal ID is assigned in accordance with similarity in the facial feature amount, and associate the personal ID assigned to the cluster, into which the feature amount is classified, with the face of the person shown in the registration images. Further, the embodiment of the present invention includes the steps of causing the information processing apparatus to extract a feature amount including a facial expression of a person shown in a key image given as search criteria, classify the facial feature amount extracted from the key image into a cluster to which a personal ID is assigned in accordance with similarity in the facial feature amount, associate a personal ID assigned to the cluster, into which the feature amount is classified, with the face of the person shown in the key image, and select an image showing the person shown in the key image that has a facial expression similar to the facial expression of the person shown in the key image.

According to an embodiment of the present invention, it is possible to select an image showing a person estimated to be related to a human subject in a key image given as search criteria from a large number of stored images.

According to another embodiment of the present invention, it is possible to select an image showing a human subject shown in a key image given as search criteria that has a facial expression similar to the facial expression of the human subject shown in the key image from a large number of stored images.

### BRIEF DESCRIPTION OF THE DRAWINGS

FIG. 1 is a block diagram illustrating a configuration example of a digital still camera to which an embodiment of the present invention is applied;

FIG. 2 illustrates a configuration example of functional blocks implemented by a control unit;

FIGS. 3A to 3C illustrate face size extraction conditions;

FIG. 4 illustrates face position extraction conditions;

FIG. 5 illustrates a configuration example of a database;

FIG. 6 is a flowchart illustrating a registration process;

FIG. 7 is a flowchart illustrating an overall evaluation value calculation process;

FIG. 8 is a flowchart illustrating a reproduction process; and

FIG. 9 is a block diagram illustrating a configuration example of a computer.

### DESCRIPTION OF THE PREFERRED EMBODIMENTS

A best mode (referred to below as an embodiment) for carrying out the present invention will now be described in detail with reference to the accompanying drawings in the following order:

1. Overview of embodiments

2. Embodiment

3. Another embodiment

4. Modification examples

### 1. OVERVIEW OF EMBODIMENTS

An embodiment in which the present invention embodied by a digital still camera performs a registration process on images, which are picked up and stored, to create a database. Next, the embodiment picks up and analyzes a key image given as search criteria, compares the database against the result of key image analysis, and searches the images, which are picked up and stored, to select images related to a human subject in the key image or select images showing the human subject in the key image that has a facial expression similar to the facial expression of the human subject in the key image. The embodiment can then perform, for instance, a slide show with the selected images.

Another embodiment in which the present invention is embodied by a computer performs a registration process on a large number of input images to create a database. Next, the other embodiment analyzes a key image given as search criteria, compares the database against the result of key image analysis, and searches the large number of input images to select images related to a human subject in the key image or select images showing the human subject in the key image that has a facial expression similar to the facial expression of the human subject in the key image. The embodiment can then perform, for instance, a slide show with the selected images.

### 2. EMBODIMENT

### [Configuration Example of Digital Still Camera]

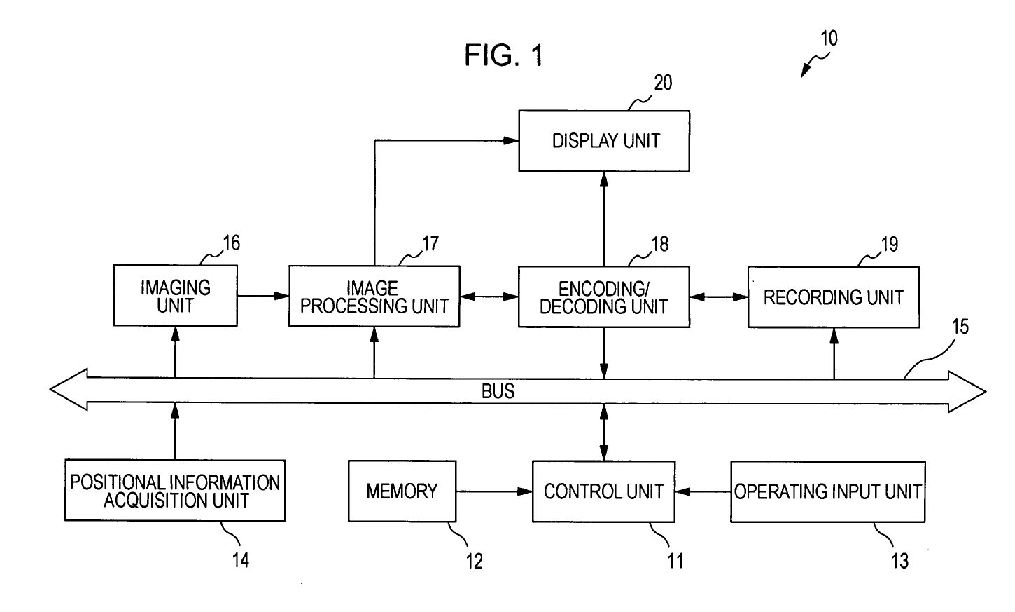

FIG. 1 shows a configuration example of a digital still camera according to an embodiment of the present invention. The digital still camera 10 includes a control unit 11, a memory 12, an operating input unit 13, a positional information acquisition unit 14, a bus 15, an imaging unit 16, an image processing unit 17, an encoding/decoding unit 18, a recording unit 19, and a display unit 20.

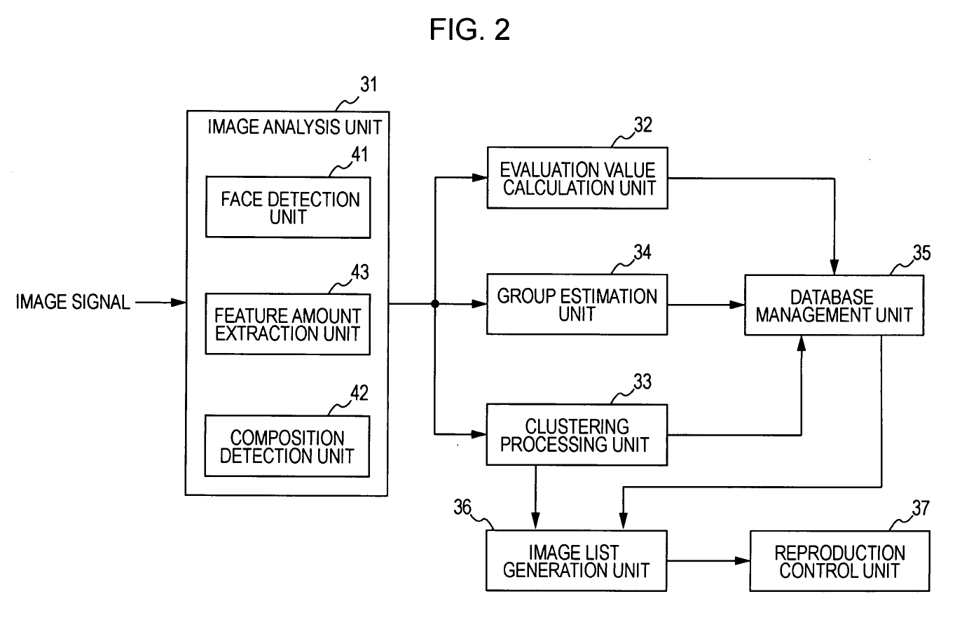

The control unit 11 controls various units of the digital still camera 10 in accordance with an operating signal that is defined by a user operation and input from the operating input unit 13. Further, the control unit 11 executes a control program recorded in the memory 12 to implement functional blocks shown in FIG. 2 and perform, for instance, a later-described registration process.

The control program is pre-recorded in the memory 12. The memory 12 also retains, for instance, a later-described subject database 38 (FIG. 5) and the result of the registration process.

The operating input unit 13 includes user interfaces such as buttons on a housing of the digital still camera 10 and a touch panel attached to the display unit 20. The operating input unit 13 generates an operating signal in accordance with a user operation and outputs the generated operating signal to the control unit 11.

The positional information acquisition unit 14 receives and analyzes a GPS (global positioning system) signal at imaging timing to acquire information indicating the date and time (year, month, day, and time) and position (latitude, longitude, and altitude) of imaging. The acquired information indicating the date, time, and position of imaging is used as exif information, which is recorded in association with a picked-up image. Time information derived from a clock built in the control unit 11 may be used as the date and time of imaging.

The imaging unit 16 includes lenses and a CCD, CMOS, or other photoelectric conversion element. An optical image of a subject, which is incident through the lenses, is converted to an image signal by the photoelectric conversion element and output to the image processing unit 17.

The image processing unit 17 performs predetermined image processing on an image signal input from the imaging unit 16, and outputs the processed image signal to the encoding/decoding unit 18. The image processing unit 17 also generates an image signal for display, for instance, by reducing the number of pixels of an image signal input from the imaging unit 16 at the time of imaging or from the encoding/decoding unit 18 at the time of reproduction, and outputs the generated image signal to the display unit 20.

At the time of imaging, the encoding/decoding unit 18 encodes an image signal input from the image processing unit 17 by the JPEG or other method, and outputs the resulting encoded image signal to the recording unit 19. At the time of reproduction, the encoding/decoding unit 18 decodes the encoded image signal input from the recording unit 19, and outputs the resulting decoded image signal to the image processing unit 17.

At the time of imaging, the recording unit 19 receives the encoded image signal input from the encoding/decoding unit 18 and records the received encoded image signal on a recording medium (not shown). The recording unit 19 also records the exif information, which is associated with the encoded image signal, on the recording medium. At the time of reproduction, the recording unit 19 reads the encoded image signal recorded on the recording medium and outputs the read encoded image signal to the encoding/decoding unit 18.

The display unit 20 includes a liquid-crystal display or the like, and displays the image of an image signal input from the image processing unit 17.

FIG. 2 illustrates a configuration example of the functional blocks that are implemented when the control unit 11 executes the control program. The functional blocks operate to perform a later-described registration process and reproduction process. Alternatively, however, the functional blocks shown in FIG. 2 may be formed by hardware such as IC chips.

An image analysis unit 31 includes a face detection unit 41, a composition detection unit 42, and a feature amount extraction unit 43. The image analysis unit 31 analyzes an image picked up and recorded on the recording medium as a processing target at the time of registration processing or analyzes a key image given as search criteria as the processing target at the time of reproduction processing, and outputs the result of analysis to subsequent units, namely, an evaluation value calculation unit 32, a clustering processing unit 33, and a group estimation unit 34.

More specifically, the face detection unit 41 detects the faces of persons in the processing target image. In accordance with the number of detected faces, the composition detection unit 42 estimates the number of human subjects in the processing target image, and classifies the number of human subjects, for instance, into a number-of-persons type of one person, two persons, three to five persons, less than ten persons, or ten or more persons. The composition detection unit 42 also classifies the processing target image as either a portrait type or a landscape type and into a composition type of face image, upper body image, or whole body image.

The feature amount extraction unit 43 examines the faces detected from the processing target image, and extracts the feature amount of a face satisfying face size extraction conditions and face position extraction conditions. In accordance with the extracted feature amount, the feature amount extraction unit 43 also estimates the facial expression of a detected face (hearty laughing, smiling, looking straight, looking into camera, crying, looking away, eyes closed, mouth open, etc.) and the age and sex of a human subject. The face size extraction conditions and the face position extraction conditions are predefined for each combination of classification results produced by the composition detection unit 42.

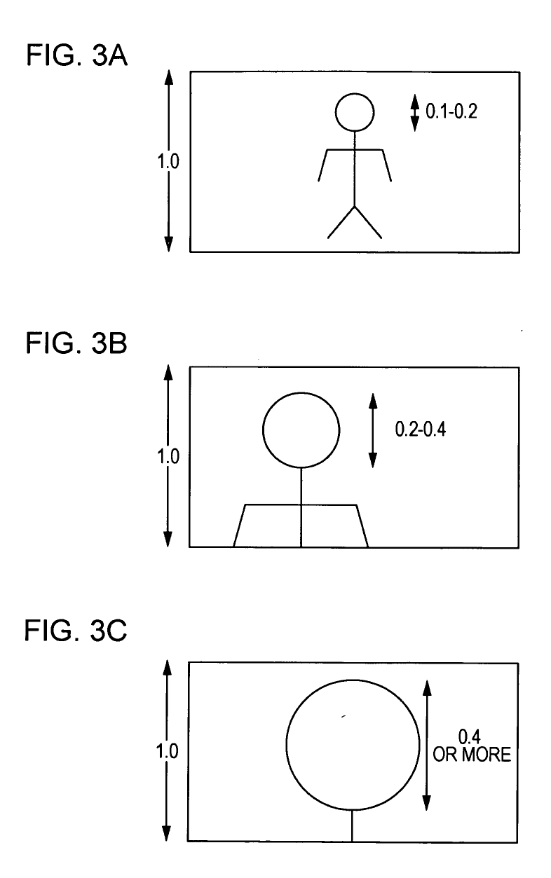

FIGS. 3A to 3C illustrate face size extraction conditions for the feature amount extraction unit 43. Circles in the images shown in FIGS. 3A to 3C represent detected faces.

FIG. 3A shows a case where the number-of-persons type is one person and a landscape type, whole body image is picked up. In this instance, it is assumed that the height of the face is 0.1 or more but less than 0.2 when the height of the image is 1.0. Faces outside this range are excluded (will not be subjected to feature amount extraction). FIG. 3B shows a case where the number-of-persons type is one person and a landscape type, upper body image is picked up. In this instance, it is assumed that the height of the face is 0.2 or more but less than 0.4 when the height of the image is 1.0. Faces outside this range are excluded. FIG. 3C shows a case where the number-of-persons type is one person and a landscape type, face image is picked up. In this instance, it is assumed that the height of the face is 0.4 or more when the height of the image is 1.0. Faces outside this range are excluded.

In a situation where the number-of-persons type is three to five persons and a landscape type, upper body image is picked up, it is assumed that the height of each face is 0.2 or more but less than 0.4 when the height of the image is 1.0. In a situation where the number-of-persons type is three to five persons and a landscape type, whole body image is picked up, it is assumed that the height of each face is 0.1 or more but less than 0.2 when the height of the image is 1.0. In a situation where the number-of-persons type is ten or more persons and a landscape type image is picked up, it is assumed that the height of each face is 0.05 or more but less than 0.3 when the height of the image is 1.0.

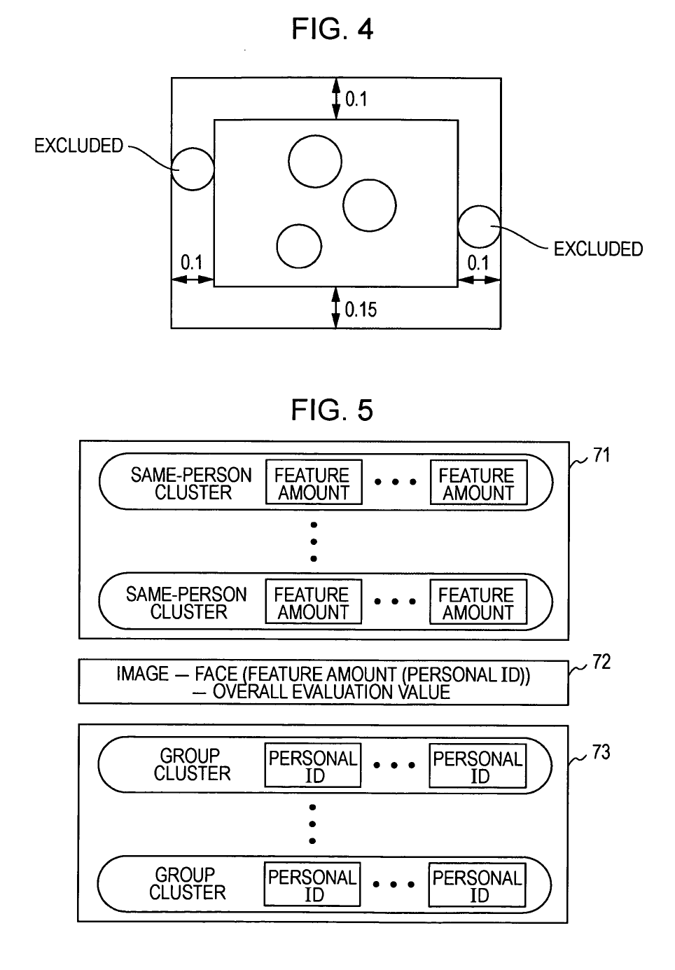

FIG. 4 illustrates face position extraction conditions for the feature amount extraction unit 43. Circles in the image shown in FIG. 4 represent detected faces.

FIG. 4 illustrates extraction conditions for a situation where the number-of-persons type is three to five persons and a landscape type, upper body image is picked up. In this instance, it is assumed that an upper 0.1 portion and a lower 0.15 portion are excluded when the image height is 1.0, and that a left-hand 0.1 portion and a right-hand 0.1 portion are excluded when the image width is 1.0. Faces detected within the above-described exception area are excluded.

The above-described extraction conditions are mere examples. Values indicating the face height and exception area are not limited to those described above.

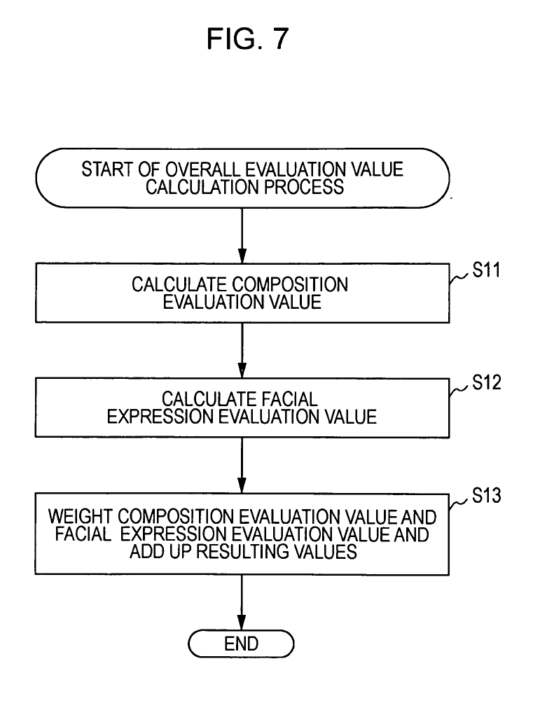

Returning to FIG. 2, the evaluation value calculation unit 32 performs calculations on the processing target image in accordance with the result of analysis by the image analysis unit 31 to obtain an overall evaluation value that evaluates the composition and the facial expression, and outputs the result of calculations to a database management unit 35. The calculation of the overall evaluation value will be described in detail with reference to FIG. 7.

The clustering processing unit 33 references same-person clusters 71 managed by the database management unit 35, classifies the facial feature amount detected in each processing target image into a same-person cluster in accordance with similarity in the facial feature amount, and outputs the result of classification to the database management unit 35. This ensures that similar faces shown in various images are classified into the same cluster (a same-person cluster to which a personal ID is assigned). This also ensures that a personal ID can be assigned to faces detected in various images.

The group estimation unit 34 references a photographed-person correspondence table 72 managed by the database management unit 35 to group each person in accordance with the frequency (high frequency, medium frequency, or low frequency) with which a plurality of persons are shown together in the same image. Further, in accordance with the frequency and the estimated sex and age of each person, the group estimation unit 34 estimates a group cluster to which each person belongs, and outputs the result of estimation to the database management unit 35. Each group cluster is classified, for instance, as a family (parents and children, married couple, and brothers and sisters included), a group of friends, or a group of persons having the same hobby or engaged in the same business.

More specifically, a group is estimated in accordance, for instance, with the following grouping standard.

A group of parents and children when photographed persons are shown together with high frequency and different in age.

A married couple when photographed persons are shown together with high frequency, different in sex, and relatively slightly different in age.

A group of brothers and sisters when photographed persons are shown together with high frequency, young, and relatively slightly different in age.

A group of friends when photographed persons are shown together with medium frequency, equal in sex, and relatively slightly different in age.

A group of persons having the same hobby when photographed persons are shown together with medium frequency, relatively large in number, and relatively slightly different in age.

A group of persons engaged in the same business when photographed persons are shown together with medium frequency, relatively large in number, adults, and widely distributed in age.

If photographed persons are shown together with low frequency, they are excluded from grouping because they are judged to be unassociated with each other and accidentally shown together within the same image.

The database management unit 35 manages the same-person clusters 71 (FIG. 5), which represent the result of classification by the clustering processing unit 33. The database management unit 35 also generates and manages the photographed-person correspondence table 72 (FIG. 5) in accordance with the same-person clusters 71 and the overall evaluation value of each image input from the evaluation value calculation unit 32. Further, the database management unit 35 manages group clusters 73 (FIG. 5), which represent the result of estimation by the group estimation unit 34.

FIG. 5 illustrates configuration examples of the same-person clusters 71, photographed-person correspondence table 72, and group clusters 73, which are managed by the database management unit 35.

Each of the same-person clusters 71 has a collection of similar feature amounts (the feature amounts of a face detected from various images). A personal ID is assigned to each same-person cluster. Therefore, the personal ID assigned to a same-person cluster into which the feature amounts of a face detected from various images are classified can be used as the personal ID of a person having the face.

The feature amounts of one or more detected faces (including the facial expression, estimated age, and sex) and associated personal IDs are recorded in the photographed-person correspondence table 72 in association with various images. Further, an overall evaluation value that evaluates the composition and the facial expression is recorded in the photographed-person correspondence table 72 in association with various images. Therefore, when, for instance, the photographed-person correspondence table 72 is searched by a personal ID, images showing a person associated with the personal ID can be identified. In addition, when the photographed-person correspondence table 72 is searched by a particular facial expression included in a feature amount, images showing a face having the facial expression can be identified.

Each of the group clusters 73 has a collection of personal IDs of persons who are estimated to belong to the same group. Information indicating the type of a particular group (a family, a group of friends, a group of persons having the same hobby, a group of persons engaged in the same business, etc.) is attached to each group cluster. Therefore, when the group clusters 73 are searched by a personal ID, a group to which a person associated with the personal ID and the type of the group can be identified. In addition, the personal IDs of the other persons in the group can be acquired.

Returning to FIG. 2, an image list generation unit 36 references the same-person clusters 71, photographed-person correspondence table 72, and group clusters 73, which are managed by the database management unit 35, finds images associated with a key image, generates a list of such images, and outputs the image list to a reproduction control unit 37. The reproduction control unit 37 receives the input list and operates, for instance, to perform a slide show in accordance with the input image list.

### [Description of Operation]

An operation of the digital still camera 10 will now be described.

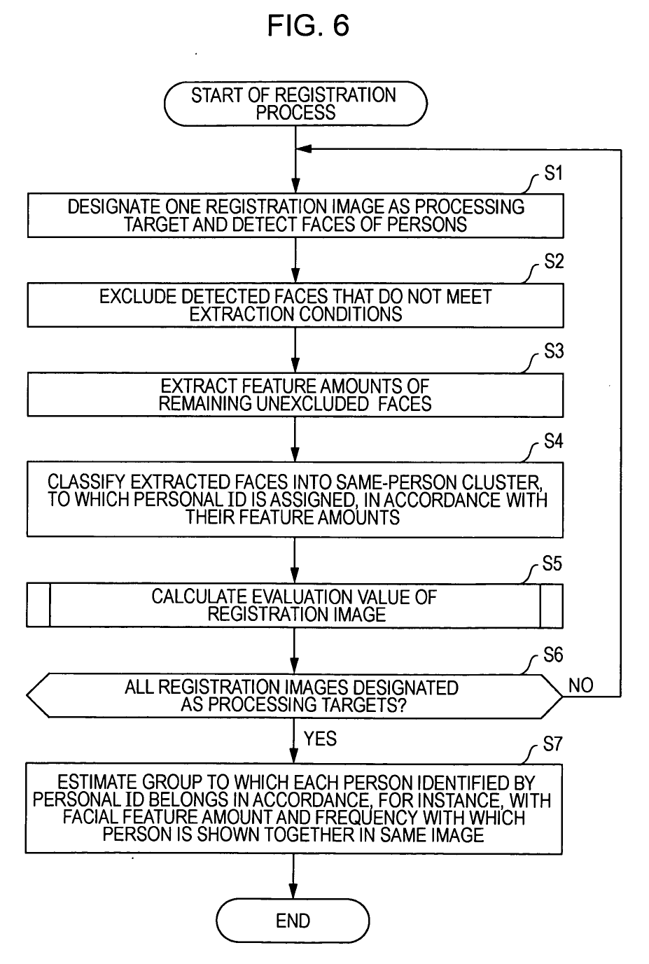

First of all, a registration process will be described below. FIG. 6 is a flowchart illustrating the registration process.

The registration process is performed on the presumption that a plurality of images showing one or more persons (referred to below as registration images) are already stored on a recording medium of the digital still camera 10. The registration process starts when a user performs a predefined operation.

In step S1, the image analysis unit 31 sequentially designates one of the plurality of stored registration images as a processing target. The face detection unit 41 detects the faces of persons from the registration image designated as the processing target. In accordance with the number of detected faces, the composition detection unit 42 identifies the number-of-persons type and composition type of the registration image designated as the processing target.

In step S2, the feature amount extraction unit 43 excludes the detected faces that do not meet the face size extraction conditions and face position extraction conditions, which are determined in accordance with the identified number-of-persons type and composition type. In step S3, the feature amount extraction unit 43 extracts the feature amount of each remaining face, which was not excluded. In accordance with the extracted feature amount, the feature amount extraction unit 43 estimates the facial expression of the detected face and the age and sex of the associated person.

Steps S1 to S3 may alternatively be performed when an image is picked up.

In step S4, the clustering processing unit 33 references the same-person clusters 71 managed by the database management unit 35, classifies the facial feature amount detected in the processing target registration images into a same-person cluster in accordance with similarity in the facial feature amount, and outputs the result of classification to the database management unit 35. The database management unit 35 manages the same-person clusters 71, which represent the result of classification by the clustering processing unit 33.

In step S5, the evaluation value calculation unit 32 calculates an overall evaluation value of the processing target registration image in accordance with the result of analysis by the image analysis unit 31, and outputs the result of calculation to the database management unit 35. The database management unit 35 generates and manages the photographed-person correspondence table 72 in accordance with the same-person clusters 71 and the overall evaluation value of each image, which is input from the evaluation value calculation unit 32.

FIG. 7 is a flowchart illustrating in detail an overall evaluation value calculation process, which is performed in step S5.

In step S11, the evaluation value calculation unit 32 calculates a composition evaluation value of a registration image. In other words, under conditions that are defined according to the number of persons shown in the registration image (the number of faces from which feature amounts are extracted), the evaluation value calculation unit 32 gives certain scores in accordance with the size of a face, the vertical and horizontal dispersions of center (gravity center) position of each face, the distance between neighboring faces, the similarity in size between neighboring faces, and the similarity in height difference between neighboring faces.

More specifically, as regards the size of a face, the evaluation value calculation unit 32 gives a predetermined score when the face sizes of all target persons are within a range defined under the conditions according to the number of photographed persons. As regards the vertical dispersion of center position of each face, the evaluation value calculation unit 32 gives a predetermined score when the dispersion is not greater than a threshold value determined under conditions according to the number of photographed persons. As regards the horizontal dispersion of center position of each face, the evaluation value calculation unit 32 gives a predetermined score when there is left/right symmetry. As regards the distance between neighboring faces, the evaluation value calculation unit 32 determines the distance between the neighboring faces with reference to face size and gives a score that increases with a decrease in the distance.

As regards the similarity in size between neighboring faces, the evaluation value calculation unit 32 gives a predetermined score when the difference in size between the neighboring faces is small because, in such an instance, the neighboring faces are judged to be at the same distance from the camera. However, when the face of an adult is adjacent to the face of a child, they differ in size. Therefore, such a face size difference is taken into consideration. As regards the similarity in height difference between neighboring faces, the evaluation value calculation unit 32 gives a predetermined score when the neighboring faces are at the same height.

The evaluation value calculation unit 32 multiplies the scores, which are given as described above, by respective predetermined weighting factors, and adds up the resulting values to calculate the composition evaluation value.

In step S12, the evaluation value calculation unit 32 calculates a facial expression evaluation value of the registration image. More specifically, the evaluation value calculation unit 32 gives certain scores in accordance with the number of good facial expression attributes (e.g., hearty laughing, looking straight, and looking into camera) of faces shown in the registration image (faces from which feature amounts are extracted), determines the average value of the faces, and multiplies the average value by a predetermined weighting factor to calculate the facial expression evaluation value.

In step S13, the evaluation value calculation unit 32 multiplies the composition evaluation value and facial expression evaluation value by respective predetermined weighting factors and adds up the resulting values to calculate an overall evaluation value.

After the overall evaluation value of the registration image is calculated as described above, processing proceeds to step S6, which is shown in FIG. 6.

In step S6, the image analysis unit 31 judges whether all the stored registration images are designated as processing targets. If all the stored registration images are not designated as processing targets, processing returns to step S1 so as to repeat steps S1 and beyond. If the judgment result obtained in step S6 indicates that all the stored registration images are designated as processing targets, processing proceeds to step S7.

In step S7, the group estimation unit 34 references the photographed-person correspondence table 72 managed by the database management unit 35, and groups a plurality of persons in accordance with the frequency with which the persons are shown together in the same image. Further, the group estimation unit 34 examines the frequency and the estimated sex and age of the persons, estimates a group cluster to which each person belongs, and outputs the result of estimation to the database management unit 35. The database management unit 35 manages the group clusters 73, which represent the result of estimation by the group estimation unit 34. The registration process is now completed.

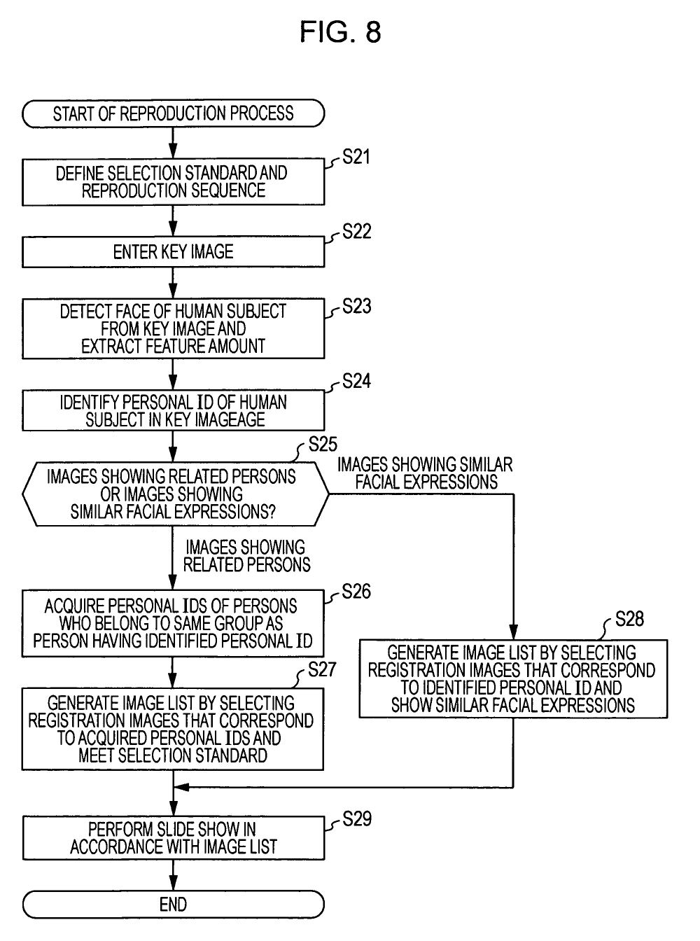

Next, a reproduction process will be described. FIG. 8 is a flowchart illustrating the reproduction process.

The reproduction process is performed on the presumption that the registration process is already performed on a plurality of registration images including an image showing a human subject in the key image, and that the same-person clusters 71, photographed-person correspondence table 72, and group clusters 73 are managed by the database management unit 35. The reproduction process starts when the user performs a predefined operation.

In step S21, the image list generation unit 36 defines a selection standard in accordance with a user operation. The selection standard is a standard for selecting an image from a plurality of registration images. The selection standard can be defined by specifying the imaging period, choosing between images showing related persons and images showing similar facial expressions, and choosing a target person, a related person, or a combination of the target person and the related person.

The imaging period can be specified, for instance, by selecting a day, a week, a month, or a year from today. Choosing between images showing related persons and images showing similar facial expressions makes it possible to select related personal images, namely, the images of persons (including the target person) related to the person in the key image in accordance with the overall evaluation value or select images showing similar facial expressions of the person in the key image in accordance with the facial expression evaluation value. Choosing a target person, a related person, or a combination of the target person and the related person makes it possible to mainly select images showing the target person in the key image, mainly select images showing a person related to the person in the key image (the target person excluded), or select a combination of the above two types of images, about half of which showing the person in the key image with the remaining half showing a person related to the person in the key image.

Further, the image list generation unit 36 defines a reproduction sequence in accordance with a user operation. The reproduction sequence can be defined to reproduce the selected images in the order of imaging date and time, in the order of overall evaluation values, in the order in which the imaging dates and times are thoroughly dispersed, or in a random order.

The user can define the selection standard and reproduction sequence each time the reproduction process is to be performed. Alternatively, however, the user can choose to use the previous settings or random settings.

In step S22, the user is prompted to pick up a key image. When the user picks up an image of an arbitrary human subject in response to such a prompt, the image enters the image analysis unit 31 as the key image. The user may alternatively select a key image from stored images instead of picking up a key image on the spot. The number of key images is not limited to one. The user may use one or more key images.

In step S23, the face detection unit 41 of the image analysis unit 31 detects the face of a person from the key image. The feature amount extraction unit 43 extracts the feature amount of the detected face, estimates the facial expression, age, and sex of the person, and outputs the result of estimation to the clustering processing unit 33.

In step S24, the clustering processing unit 33 references the same-person clusters 71 managed by the database management unit 35, selects a same-person cluster in accordance with similarity to the facial feature amount detected in the key image, identifies the personal ID assigned to the selected same-person cluster, and notifies the image list generation unit 36 of the personal ID.

In step S25, the image list generation unit 36 checks whether images showing related persons or images showing similar facial expressions are selected to define the selection standard in step S21. If the images showing related persons are selected, the image list generation unit 36 proceeds to step S26.

In step S26, the image list generation unit 36 references the group clusters 73 managed by the database management unit 35, identifies a group cluster to which the personal ID identified with respect to the person in the key image belongs, and acquires personal IDs constituting the identified group cluster (the personal IDs of persons belonging to a group to which the person in the key image belongs, including the personal IDs associated with the person in the key image).

In step S27, the image list generation unit 36 references the photographed-person correspondence table 72 managed by the database management unit 35, and extracts registration images showing the persons having the acquired personal IDs. Thus, the registration images showing the persons related to the person in the key image are extracted. Further, the image list generation unit 36 generates an image list by selecting a predetermined number of extracted registration images having relatively great overall evaluation values in accordance with the selection standard defined in step S21.

If, on the other hand, the result of the check in step S25 indicates that images showing similar facial expressions are selected, the image list generation unit 36 proceeds to step S28.

In step S28, the image list generation unit 36 references the photographed-person correspondence table 72 managed by the database management unit 35, and extracts registration images showing the person in the key image that has similar facial expressions. The registration images showing similar facial expressions can be extracted by selecting registration images that have a difference (Euclidean distance) equal to or smaller than a predetermined threshold value when a facial-expression-related component of facial feature amounts is regarded as a multidimensional vector. Further, the image list generation unit 36 generates an image list by selecting a predetermined number of extracted registration images having relatively great overall evaluation values in accordance with the selection standard defined in step S21.

In step S29, the reproduction control unit 37 reproduces the registration images in the image list, which is generated by the image list generation unit 36, in the reproduction sequence defined in step S21. The reproduction process is now completed.

According to the reproduction process described above, it is possible to select registration images showing persons closely related to the person in the key image (including the person in the key image) or select registration images showing the person in the key image that has the same facial expression. Further, the selected registration images can be used, for instance, to perform a slide show.

As described above, the reproduction process is performed on the presumption that the registration images include images showing the human subject in the key image. However, such a presumption is not a prerequisite. More specifically, even when the human subject in the key image is not shown in the registration images, registration images showing persons similar to the human subject in the key image (not only parents, sons and daughters, brothers and sisters of the human subject in the key image but also genetically unrelated persons) are selected for listing purposes. Therefore, an interesting image list can be generated.

According to the registration process and reproduction process, it is possible to select and present appropriate images, for instance, of not only a target person but also his/her family members by picking up an image of the target person to be shown in a slide show as a key image. It is alternatively possible to select and present images showing facial expressions similar to the facial expression shown in the key image.

### 3. ANOTHER EMBODIMENT

### [Configuration Example of Computer]

In the foregoing embodiment, which describes the digital still camera 10, images picked up by the digital still camera 10 are used as the registration images and key image. In another embodiment, which describes a computer, the computer performs the registration process on a plurality of input images and performs the reproduction process in accordance with a key image input from the outside.

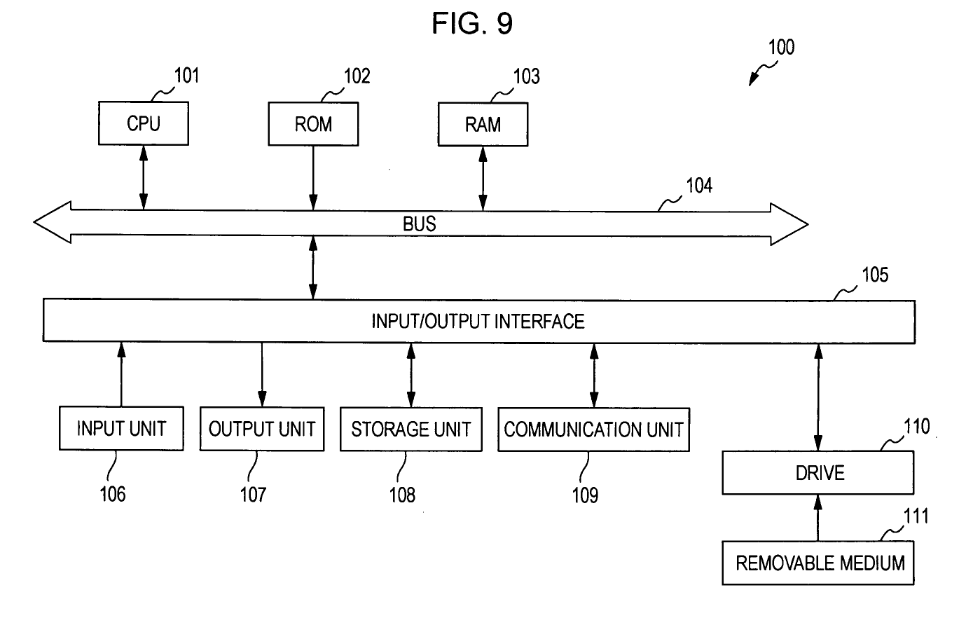

FIG. 9 illustrates a configuration example of the computer according to the other embodiment. In the computer 100, a CPU (central processing unit) 101, a ROM (read-only memory) 102, and a RAM (random access memory) 103 are interconnected through a bus 104.

The bus 104 is also connected to an input/output interface 105. The input/output interface 105 is connected to an input unit 106, which includes, for instance, a keyboard, a mouse, and a microphone; an output unit 107, which includes, for instance, a display and a speaker; a storage unit 108, which includes, for instance, a hard disk and a nonvolatile memory; a communication unit 109, which includes, for instance, a network interface; and a drive 110, which drives a removable medium 111 such as a magnetic disk, an optical disk, a magneto-optical disk, or a semiconductor memory.

In the computer configured as described above, the CPU 101 performs the above-described registration process and reproduction process by loading a program stored in the storage unit 108 into the RAM 103 through the input/output interface 105 and bus 104 and executing the loaded program.

The program to be executed by the computer may perform time-series processing in a sequence described in this specification or perform processing in a parallel manner or at an appropriate timing such as when recalled.

### 4. MODIFICATION EXAMPLES

The embodiments of the present invention are not limited to the above descriptions. Various modifications can be made without departing from the spirit and scope of the present invention. Further, the embodiments of the present invention can be extended as described below.

The embodiments of the present invention can be applied not only to a case where images to be displayed in a slide show are to be selected, but also to a case where images to be included in a photo collection are to be selected.

The embodiments of the present invention can also be applied to a case where images are to be searched by using a key image as search criteria.

When a plurality of images are used as key images, the image list may be compiled by allowing the user to choose either the logical sum or logical product of selection results derived from the individual key images. This makes it possible, for instance, to select registration images that simultaneously show all the persons shown in the key images or select registration images that show all the persons shown in the key images on an individual basis.

When an image of a person is picked up and employed as a key image, images showing facial expressions similar to the facial expression shown in the key image may be selected from stored images and displayed while the key image is displayed for review purposes.

The timing at which a key image is picked up may be determined by the camera instead of a user operation. More specifically, a key image may be picked up when a human subject is detected in a finder image area so as to select and display images related to the detected human subject or images showing facial expressions similar to the facial expression shown in the key image.

A landscape may be employed as a key image. This makes it possible, for instance, to select images showing mountains similar to mountains shown in the key image or select images showing seashore similar to seashore shown in the key image.

The present application contains subject matter related to that disclosed in Japanese Priority Patent Application JP 2009-262513 filed in the Japan Patent Office on Nov. 18, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus that searches a plurality of registration images to select images satisfying search criteria, the information processing apparatus comprising:
estimation means for estimating a group to which a subject shown in the registration images belongs in accordance with the frequency with which the subject is shown together in the same image; and
selection means for selecting an image showing a subject which is estimated to belong to the same group as a subject shown in a key image given as search criteria from the plurality of the registration images in a situation where a group to which the subject belongs is estimated.

2. The information processing apparatus according to claim 1, further comprising:
image analysis means for extracting a feature amount of a part of a subject shown in an image;
classification means for classifying the feature amount, which is extracted from the image, into a cluster to which an ID is assigned, in accordance with similarity in the feature amount; and
association means for associating the ID assigned to the cluster, into which the feature amount is classified, with the part of the subject shown in the image.

3. The information processing apparatus according to claim 2, further comprising:
calculation means for calculating evaluation values of the registration images in accordance with the result of analysis by the image analysis means;
wherein the selection means selects images showing a subject estimated to belong to the same group as the subject shown in the key image from the plurality of registration images in the order of the evaluation values.

4. The information processing apparatus according to claim 3, wherein the calculation means calculates the evaluation values of the registration images in accordance with compositions of the registration images as well as the result of analysis by the image analysis means.

5. The information processing apparatus according to claim 3, further comprising:
imaging means for picking up at least one of the registration images and the key image.

6. The information processing apparatus according to claim 2, wherein the subject is a person and the part of the subject is a face of a person.

7. An information processing method for use in an information processing apparatus that searches a plurality of registration images to select images satisfying search criteria, the method comprising the steps of:
estimating a group to which a subject shown in the registration images belongs in accordance with the frequency with which the subject is shown together in the same registration images; and
selecting an image showing a subject which is estimated to belong to the same group as the subject shown in the key image given as search criteria from the plurality of the registration images in a situation where a group to which the subject belongs is estimated.

8. A program controlling an information processing apparatus that searches a plurality of registration images to select images satisfying search criteria and causing a computer included in the information processing apparatus to perform a process including the steps of:
estimating a group to which a subject shown in the registration images belongs in accordance with the frequency with which the subject is shown together in the same registration images; and
selecting an image showing a subject which is estimated to belong to the same group as the subject shown in the key image given as search criteria from the plurality of the registration images in a situation where a group to which the subject belongs is estimated.

9. An information processing apparatus that searches a plurality of registration images to select images satisfying search criteria, the information processing apparatus comprising:
image analysis means for extracting a feature amount including a facial expression of a person shown in an image;
classification means for classifying the facial feature amount, which is extracted from the image, into a cluster to which a personal ID is assigned, in accordance with similarity in the facial feature amount;
association means for associating the personal ID assigned to the cluster, into which the feature amount is classified, with the face of the person shown in the image; and
selection means for selecting an image showing a person shown in a key image given as search criteria that has a facial expression similar to the facial expression of the person shown in the key image from the plurality of analyzed registration images showing the face of a person to which a personal ID is assigned.

10. The information processing apparatus according to claim 7, further comprising:
calculation means for calculating evaluation values of the registration images in accordance with the result of analysis by the image analysis means;
wherein the selection means selects images showing a person shown in the key image that have facial expressions similar to the facial expression of the person shown in the key image from the plurality of registration images in the order of the evaluation values.

11. The information processing apparatus according to claim 8, wherein the calculation means calculates the evaluation values of the registration images in accordance with compositions of the registration images as well as the result of analysis by the image analysis means.

12. The information processing apparatus according to claim 8, further comprising:
imaging means for picking up at least one of the registration images and the key image.

13. An information processing method for use in an information processing apparatus that searches a plurality of registration images to select images satisfying search criteria, the method comprising the steps of:
extracting a feature amount including a facial expression of a person shown in the plurality of registration images;
classifying the facial feature amount, which is extracted from the registration images, into a cluster to which a personal ID is assigned, in accordance with similarity in the facial feature amount;
associating the personal ID assigned to the cluster, into which the feature amount is classified, with the face of the person shown in the registration images;
extracting a feature amount including a facial expression of a person shown in a key image given as search criteria;
classifying the facial feature amount extracted from the key image into a cluster to which a personal ID is assigned in accordance with similarity in the facial feature amount;
associating the personal ID assigned to the cluster, into which the feature amount is classified, with the face of the person shown in the key image; and
selecting an image showing the person shown in the key image that has a facial expression similar to the facial expression of the person shown in the key image.

14. A program controlling an information processing apparatus that searches a plurality of registration images to select images satisfying search criteria and causing a computer included in the information processing apparatus to perform a process including the steps of:
extracting a feature amount including a facial expression of a person shown in the plurality of registration images;
classifying the facial feature amount, which is extracted from the registration images, into a cluster to which a personal ID is assigned, in accordance with similarity in the facial feature amount;
associating the personal ID assigned to the cluster, into which the feature amount is classified, with the face of the person shown in the registration images;
extracting a feature amount including a facial expression of a person shown in a key image given as search criteria;
classifying the facial feature amount extracted from the key image into a cluster to which a personal ID is assigned in accordance with similarity in the facial feature amount;
associating the personal ID assigned to the cluster, into which the feature amount is classified, with the face of the person shown in the key image; and
selecting an image showing the person shown in the key image that has a facial expression similar to the facial expression of the person shown in the key image.

15. An information processing apparatus that searches a plurality of registration images to select images satisfying search criteria, the information processing apparatus comprising:
an image analysis unit extracting a feature amount of a face of a person shown in an image;
a classification unit classifying the facial feature amount, which is extracted from the image, into a cluster to which a personal ID is assigned, in accordance with similarity in the facial feature amount;
an association unit associating the personal ID assigned to the cluster, into which the feature amount is classified, with the face of the person shown in the image;
an estimation unit estimating a group to which a person shown in the registration images belongs in accordance with the frequency with which the person is shown together in the same image; and
a selection unit selecting an image showing a person who is estimated to belong to the same group as a person shown in a key image given as search criteria from the plurality of analyzed registration images showing the face of a person to which a personal ID is assigned in a situation where a group to which the person belongs is estimated.

16. An information processing apparatus that searches a plurality of registration images to select images satisfying search criteria, the information processing apparatus comprising:
an image analysis unit extracting a feature amount including a facial expression of a person shown in an image;
a classification unit classifying the facial feature amount, which is extracted from the image, into a cluster to which a personal ID is assigned, in accordance with similarity in the facial feature amount;
an association unit associating the personal ID assigned to the cluster, into which the feature amount is classified, with the face of the person shown in the image; and
a selection unit selecting an image showing a person shown in a key image given as search criteria that has a facial expression similar to the facial expression of the person shown in the key image from the plurality of analyzed registration images showing the face of a person to which a personal ID is assigned.
